(19) United States
(12) Patent Application Publication
(10) Pub. No.: US 2018/0253039 A1
(43) Pub. Date: Sep. 6, 2018

(54) IMAGE FORMING APPARATUS

(71) Applicant: CANON KABUSHIKI KAISHA, Tokyo (JP)

(72) Inventor: Yutaka Kakehi, Kashiwa-shi (JP)

(21) Appl. No.: 15/902,523

(22) Filed: Feb. 22, 2018

(30) Foreign Application Priority Data
Mar. 1, 2017 (JP) 2017-038476

(51) Int. Cl. G03G 15/16

(52) U.S. Cl. CPC G03G 15/1675; G03G 15/04072; G03G 15/0189; G03G 15/751

(57) ABSTRACT

An image forming apparatus including:
an image bearing member;
a transfer member;
a power supply;
a conveyance path;
a first detection portion;
a second detection portion; and
a controller configured to control a bias to be applied to the transfer member,
wherein the controller controls a voltage to be applied to the transfer member when a first region of a recording material passes through a transfer portion, based on a detection result obtained by detecting the first region of the recording material by the first detection portion and a detection result obtained by detecting a second region of the recording material which is downstream of the first region with respected to a conveying direction of the recording material by the first detection portion, and a detection result detected by the second detection portion at a timing when the second region passes through the transfer portion.

### BACKGROUND OF THE INVENTION

### Field of the Invention

The present invention relates to an image forming apparatus such as an electrophotographic copying machine or an electrophotographic printer (for example, a laser beam printer or an LED printer).

### Description of the Related Art

To form an image in an image forming apparatus using an electrophotographic system, a toner image borne on a photosensitive member or an intermediate transfer member as an image bearing member is electrostatically transferred onto a recording material such as a sheet by applying a voltage to a transfer member.

When the voltage applied to the transfer member is insufficient with respect to a charge amount of a toner constituting the toner image, the toner image cannot be sufficiently transferred onto the recording material, and a desired image density cannot be obtained. On the other hand, when the voltage is too high, a discharge occurs in a transfer portion, and thus the toner image tends to become a void image. Therefore, in order to obtain high-quality image artifacts, it is necessary to optimize the voltage applied to the transfer member.

However, the electrical resistance of the recording material largely varies depending on the type of the recording material or environmental conditions such as the temperature and humidity of a place where the image forming apparatus is positioned, and thus an appropriate value of the voltage applied to the transfer member also varies. From this background, a configuration for optimizing a setting value of a voltage applied to a transfer member has been conventionally proposed.

For example, Japanese Patent Laid-Open No. 2008-268385 discloses a configuration in which a detection unit that detects an electrical resistance of a recording material or a moisture content having a great correlation with the electrical resistance is provided in a housing of an image forming apparatus, and a voltage to be applied to a transfer member is controlled according to the detection result of the detection unit

In addition, Japanese Patent Laid-Open No. 2003-302846 discloses a configuration in which an electrical resistance of a recording material is read from a value of a current flowing when a predetermined voltage is applied to a leading end portion of the recording material, and an appropriate value of a voltage to be applied to portions other than the leading end portion of the recording material is obtained from the electrical resistance.

The electrical resistance of the recording material largely varies depending on the contact property between the recording material and a member facing the recording material. For example, in order to stabilize an electric field at the time of applying a voltage to a transfer member, a configuration in which a transfer member such as a transfer roller made of a foamed conductive rubber member is brought into contact with a position facing an image bearing member to form a transfer portion is often adopted. With this configuration, an electrical resistance of the recording material in the transfer portion varies due to a change in a pressure which presses the transfer member against the image bearing member in a state in which the recording material is conveyed to the transfer portion and nipped, or a change in the contact property between the recording material and the image bearing member depending on a shape or the like of the transfer member.

Therefore, in the configuration that detects the electrical resistance of the recording material at a position other than the transfer portion as disclosed in Japanese Patent Laid-Open No. 2008-268385, the electrical resistance of the recording material detected by the detection unit may be different from the electrical resistance of the recording material in the transfer portion, and the setting value of the voltage to be applied to the transfer member may not be optimized.

In addition, unevenness of the moisture content of the recording material easily occurs in a process in which, for example, the recording material is placed in a deck accommodating the recording material and the moisture content changes according to the surrounding environment. In particular, in a state in which the recording materials are stacked, a change in a moisture content is great in an edge portion exposed to the surrounding environment, and a change in a moisture content is small in the other portions. Therefore, in the configuration that detects the resistance of the leading end portion of the recording material in the transfer portion and corrects the value of the voltage to be applied to portions other than the leading end portion, it is difficult to optimize the voltage to be applied to the transfer member when the electrical resistance of the recording material is not uniform due to the unevenness of the moisture content.

### SUMMARY OF THE INVENTION

It is desirable to provide an image forming apparatus capable of appropriately setting a voltage to be applied to a transfer member according to a detection result of information corresponding to an electrical resistance of a recording material.

A representative configuration of the present invention is an image forming apparatus including:

an image bearing member configured to bear a toner image;

a transfer member configured to come in contact with the image bearing member to form a transfer portion which transfers the toner image borne on the image bearing member to a recording material;

a power supply configured to apply a voltage to the transfer member;

a conveyance path through which the recording material is conveyed toward the transfer portion;

a first detection portion disposed on the conveyance path and configured to detect information concerning a moisture content of the recording material;

a second detection portion configured to detect a current flowing when the power supply applies a voltage to the transfer member or the applied voltage; and

a controller configured to control a bias to be applied to the transfer member when the recording material passes through the transfer portion,

wherein the controller controls a voltage to be applied to the transfer member when a first region of the recording material passes through the transfer portion, based on a detection result obtained by detecting the first region of the recording material by the first detection portion and a detection result obtained by detecting a second region of the recording material which is downstream of the first region with respected to a conveying direction of the recording material by the first detection portion, and a detection result detected by the second detection portion at a timing when the second region passes through the transfer portion.

Further features of the present invention will become apparent from the following description of exemplary embodiments with reference to the attached drawings.

### BRIEF DESCRIPTION OF THE DRAWINGS

FIG. 1 is a schematic cross-sectional view of an image forming apparatus.

FIG. 2 is a schematic view illustrating a configuration of a moisture content detection sensor.

FIG. 3 is a block diagram illustrating a part of a system configuration of the image forming apparatus.

FIG. 4 is a graph illustrating a relationship between a secondary transfer bias value for causing a current of a predetermined value to flow in a secondary transfer portion and a resistance value of a sheet detected at a position other than the secondary transfer portion in various types of sheets.

FIG. 5 is a flowchart of a control sequence at the time of applying a secondary transfer bias.

FIG. 6 is a table in which a moisture content and a basis weight of a sheet are associated with a secondary transfer bias value corresponding to a sheet resistance.

FIG. 7 is a graph illustrating a secondary transfer bias value corresponding to a sheet resistance along a position in a sheet conveying direction.

FIG. 8 is a graph illustrating a secondary transfer bias value corresponding to a sheet resistance along a position in the sheet conveying direction.

FIG. 9 is a flowchart of a control sequence at the time of applying a secondary transfer bias.

### DESCRIPTION OF THE EMBODIMENTS

### First Embodiment

### <Image Forming Apparatus>

First, an overall configuration of an image forming apparatus A according to a first embodiment of the present invention will be described with reference to the drawings together with an operation at the time of image formation. It is noted that the dimensions, materials, shapes, relative arrangements, and the like of components described herein are not intended to limit the scope of the present invention, unless otherwise specified.

The image forming apparatus A is an intermediate transfer tandem type color image forming apparatus which transfers toners of four colors, that is, yellow Y, magenta M, cyan C, and black K, to an intermediate transfer belt, and then transfers an image onto a sheet to form an image. In the following description, the suffixes Y, M, C, and K are assigned to the members using the toners of the respective colors, but the configuration and operation of each member are substantially the same except that the color of the toner used is different. Therefore, the suffixes are omitted as appropriate unless distinction is required.

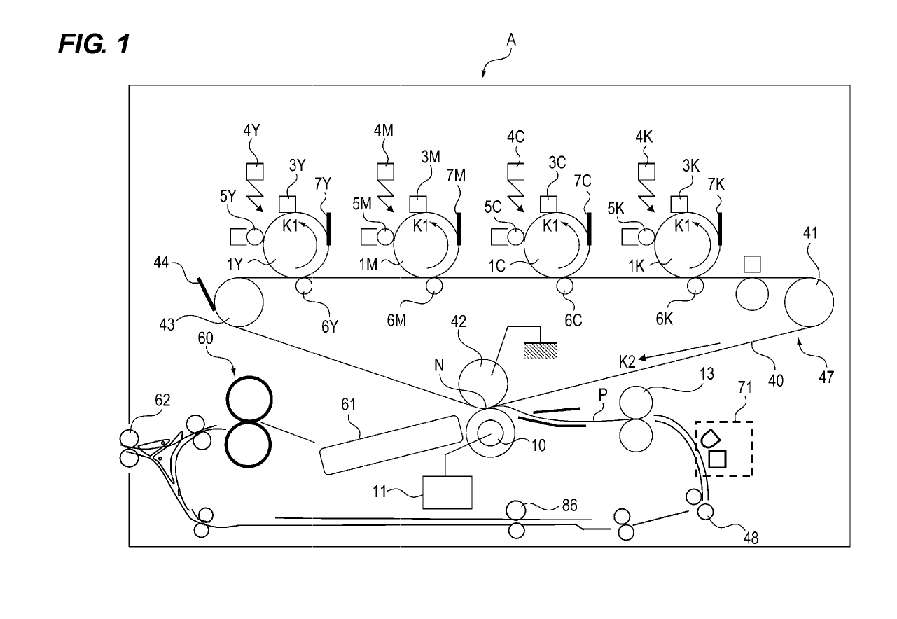

As illustrated in FIG. 1, the image forming apparatus A includes an image forming portion which transfers a toner image onto a sheet P serving as a recording material, a sheet feeding portion which feeds the sheet P to the image forming portion, and a fixing portion which fixes the toner image onto the sheet P.

The image forming portion includes a photosensitive drum 1 (1Y, 1M, 1C, 1K) and a charging member 3 (3Y, 3M, 3C, 3K) which charges the surface of the photosensitive drum 1. The image forming portion also includes a drum cleaner 7 (7Y, 7M, 7C, 7K), a laser scanner unit 4 (4Y, 4M, 4C, 4K), a developing device 5 (5Y, 5M, 5C, 5K), and an intermediate transfer unit 47.

The intermediate transfer unit 47 includes a primary transfer roller 6 (6Y, 6M, 6C, 6K), an intermediate transfer belt 40 (image bearing member, intermediate transfer member), a tension roller 41, a secondary transfer roller 10 (transfer member), a secondary transfer counter roller 42, a driving roller 43, and a belt cleaner 44.

The intermediate transfer belt 40 is an endless cylindrical belt having a three-layer structure including a resin layer, an elastic layer, and a front surface layer from a back surface side, and a conductive agent for adjusting a resistance value of carbon black or the like is added to the belt to obtain a volume resistivity of 1×10⁹ to 1×10¹⁴ Ω·cm. As a resin material constituting the resin layer, a material such as polyimide or polycarbonate is used, and a thickness thereof is 70 to 100 μm. As a material constituting the elastic layer, a material such as urethane rubber or chloroprene rubber is used, and a thickness thereof is 200 to 250 μm.

In addition, a material of the front surface layer is required to reduce an adhesion force of a toner to a front surface of the intermediate transfer belt 40, such that the toner is easily transferred onto a sheet P in a secondary transfer portion N formed by the secondary transfer roller 10 and the intermediate transfer belt 40. For example, one resin material selected from among polyurethane, polyester, and epoxy resin can be used. In addition, a material which reduces surface energy and increases lubricity by using two or more elastic materials selected from among elastic rubber, elastomer, and butyl rubber, one or more kinds of powder particles such as fluororesin, or powder particles having different particle sizes can be dispersed and used. The thickness of the front surface layer is 5 to 10 μm.

In addition, the intermediate transfer belt 40 extends between the primary transfer roller 6, the tension roller 41, the secondary transfer counter roller 42, and the driving roller 43. The driving roller 43 receives a rotational driving force from a driving source (not illustrated) and rotates, and the intermediate transfer belt 40 is driven to rotate by this rotation to make a circulating movement in a direction of an arrow K2 at a speed of about 300 to 500 mm/sec.

The tension roller 41 is a roller-shaped member which exerts a force so as to push the intermediate transfer belt 40 toward the front surface side by a force of a spring, so that a tension of about 2 to 5 kgf is applied to the intermediate transfer belt 40.

The secondary transfer roller 10 is a roller member including an elastic layer of an ion-conductive foamed rubber (NBR rubber) and a core metal and has an outer diameter of 24 mm and a roller surface roughness Rz of 6.0 to 12.0 μm. In addition, the electrical resistance is 1×10⁵ to 1×10⁷Ω at application of 2 kV when measured at N/N (23° C., 50% RH), and hardness of the elastic layer is about 30 to 40 in Asker C hardness. Further, a secondary transfer power supply 11 in which a bias (voltage) to be applied is variable is attached to the secondary transfer roller 10.

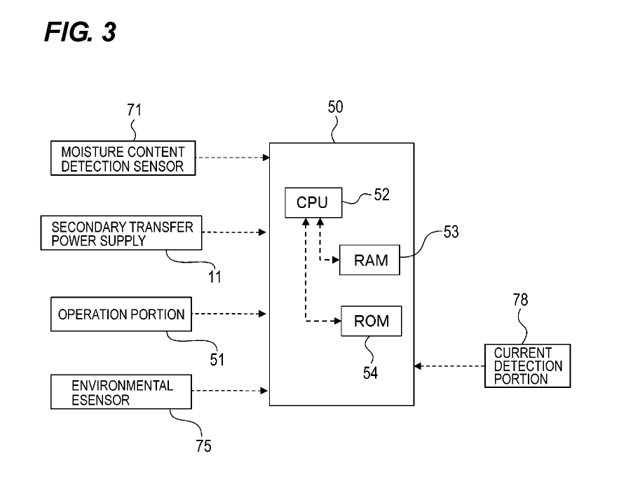

Next, an image forming process will be described. First, when a controller 50 illustrated in FIG. 3 receives an image forming job signal, a sheet P stacked and stored in a sheet feeding cassette (not illustrated) is conveyed to a registration roller 13 by a feeding roller (not illustrated) and a conveying roller 48. The registration roller 13 conveys the sheet P to the secondary transfer portion N in synchronization with a timing when a toner image on the intermediate transfer belt 40 is conveyed to the secondary transfer portion N.

Meanwhile, in the image forming portion, the surface of the photosensitive drum 1 rotating in a direction of an arrow K1 is charged by applying a charging bias to the charging member 3. After that, the laser scanner unit 4 irradiates the surface of the photosensitive drum 1 with a laser beam according to an image signal transmitted from an external device (not illustrated) or the like to perform exposure, and forms an electrostatic latent image on the surface of the photosensitive drum 1.

The electrostatic latent image formed by the laser scanner unit 4 is an aggregate of small dot images, and the density of the toner image formed on the photosensitive drum 1 can be changed by changing the density of the dot images. In the present embodiment, a maximum density of each color toner image is about 1.5 to 1.7, and a toner application amount at the maximum density is about 0.4 to 0.6 mg/cm².

After that, the developing device 5 attaches a toner to the electrostatic latent image formed on the surface of the photosensitive drum 1 to form a toner image on the surface of the photosensitive drum 1. In the present embodiment, a reversal developing method of attaching a toner to an exposed portion on the photosensitive drum 1 is used.

The toner image formed on the surface of the photosensitive drum 1 is sent to the primary transfer portion formed by the photosensitive drum 1 and the primary transfer roller 6. The toner image of each color sent to the primary transfer portion is primarily transferred to the intermediate transfer belt 40 by applying a primary transfer bias having a polarity opposite to a charge polarity of the toner to the primary transfer roller 6. In this manner, a full-color toner image is formed on the intermediate transfer belt 40 (on the image bearing member).

After that, the toner image is sent to the secondary transfer portion N by the rotation of the intermediate transfer belt 40. In the secondary transfer portion N, a secondary transfer bias having a polarity opposite to a charge polarity of the toner is applied to the secondary transfer roller 10, whereby the toner image on the intermediate transfer belt 40 is transferred onto the sheet P. That is, the secondary transfer portion N is a transfer portion in which the toner image borne on the intermediate transfer belt 40 as the image bearing member is transferred onto the sheet P. In the present embodiment, the control is performed such that a current of about 40 to 60 μA flows when the secondary transfer bias is applied, but the method of setting the secondary transfer bias will be described later in detail.

The sheet P onto which the toner image has been transferred is sent to a fixing device 60, is heated and pressed by the fixing device 60 to fix the toner image on the sheet P, and is then discharged from the image forming apparatus A by a discharge roller 62.

The toner remaining on the surface of the photosensitive drum 1 after the primary transfer is scraped off and removed by the drum cleaner 7. Further, the toner remaining on the intermediate transfer belt 40 after the secondary transfer is scraped off and removed by the belt cleaner 44.

### <Moisture Content Detection Sensor>

The image forming apparatus A includes a moisture content detection sensor 71 which detects a moisture content of the sheet P as a first detection portion which detects information corresponding to the electrical resistance of the sheet P. As illustrated in FIG. 1, the moisture content detection sensor 71 is disposed on a conveyance path which conveys the sheet P toward the secondary transfer portion N. In the present embodiment, the moisture content detection sensor 71 is disposed at a position between the registration roller 13 and the conveying roller 48.

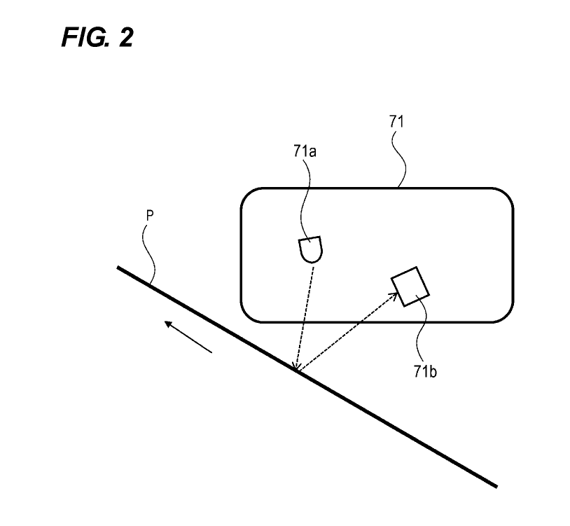

FIG. 2 is a schematic view illustrating the configuration of the moisture content detection sensor 71. As illustrated in FIG. 2, the moisture content detection sensor 71 includes a light emitting element 71a which irradiates the sheet P with near-infrared light, and a light receiving element 71b which receives the near-infrared light reflected from the sheet P.

The near-infrared light is light having a wavelength of 0.8 to 2.5 μm and has a property that an amount of reflection greatly changes depending on a moisture content in a material. Therefore, the moisture content detection sensor 71 detects the moisture content of the sheet P by detecting an infrared dose of the light emitted from the light emitting element 71a and reflected by the sheet P using the light receiving element 71b.

There is a correlation between the moisture content of the sheet P and the electrical resistance. As the moisture content is lower, the sheet P becomes drier and the electrical resistance becomes higher. Therefore, by preliminarily establishing the correlation between the moisture content and the electrical resistance of the sheet P, the electrical resistance of the sheet P can be obtained from the detected moisture content.

### <Controller>

Next, the overview of the system configuration of the image forming apparatus A will be described.

FIG. 3 is a block diagram illustrating a part of the system configuration of the image forming apparatus A. As illustrated in FIG. 3, the image forming apparatus A includes a controller 50 (control circuit, setting portion) configured by a CPU 52, a RAM 53, and a ROM 54. In addition, an operation portion 51, the secondary transfer power supply 11, an environmental sensor 75, and a current detection portion 78 are connected to the controller 50.

The ROM 54 stores control programs or various data, tables, and the like. The CPU 52 performs a variety of arithmetic processing based on the control programs or information stored in the ROM 54. The RAM 53 includes a program load area, a work area, a storage area for various data, and the like.

In other words, the controller 50 controls each device of the image forming apparatus Awhile the CPU 52 uses the RAM 53 as the work area based on the control programs stored in the ROM 54. Then, the image forming operation described above can be executed through the control of each device.

The current detection portion 78 (second detection portion) detects a value of a current flowing when a secondary transfer bias is applied from the secondary transfer power supply 11 to the secondary transfer roller 10. The current detection portion 78 detects the current value by measuring a current flowing through a current detection resistor element (not illustrated) disposed in a high-voltage substrate of the secondary transfer power supply 11 by using a current measuring device (not illustrated) disposed in the high-voltage substrate.

In addition, the controller 50 can control the secondary transfer power supply 11 (power supply) to apply a predetermined secondary transfer bias to the secondary transfer roller 10. Further, the user can make various settings by operating the operation portion 51, or can execute an image forming job. Further, the environmental sensor 75 detects temperature information and humidity information of the image forming apparatus A and outputs the temperature information and the humidity information to the controller 50.

### <Control at Time of Applying Secondary Transfer Bias>

Next, the control at the time of applying the secondary transfer bias will be described.

In the present embodiment, the moisture content detection sensor 71 detects the moisture content in the entire region of the sheet P in a conveying direction, and the controller 50 detects the electrical resistance of the entire sheet P in the conveying direction based on the detected moisture content. Specifically, when the sheet P is conveyed to the moisture content detection sensor 71, the moisture content of the sheet P is detected at a plurality of timings. Therefore, even when there is resistance unevenness in the sheet P, the secondary transfer bias corresponding to the unevenness can be applied by setting a secondary transfer bias value according to the electrical resistance of the sheet P which changes in the sheet conveying direction from this detection result.

However, as described above, the electrical resistance of the sheet P detected at a position other than the secondary transfer portion N is different from the electrical resistance of the sheet P in the secondary transfer portion N. That is, the electrical resistance of the sheet P in the secondary transfer portion N largely depends on a contact state between the sheet P and a counter member facing the sheet P in the secondary transfer portion N, and this contact state differs depending not only on a hardware factor for forming the secondary transfer portion N but also on a difference in surface properties such as the surface roughness of the sheet P.

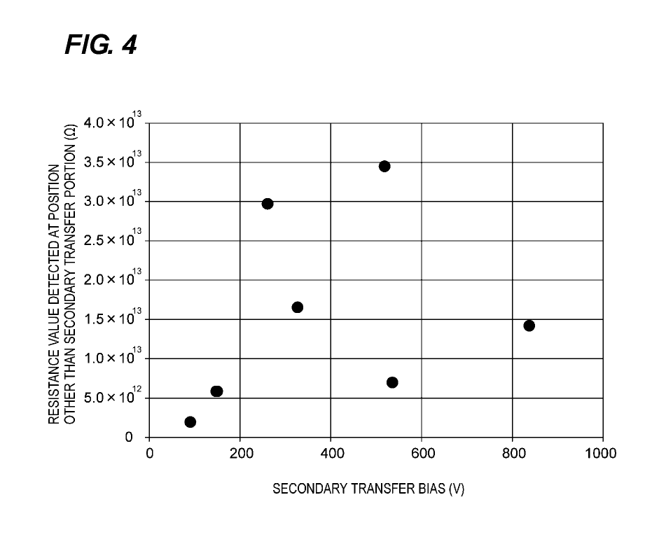

FIG. 4 is a graph illustrating a relationship between a secondary transfer bias value for causing a current of a predetermined value to flow in the secondary transfer portion N and an electrical resistance (resistance value) of the sheet P detected at a position other than the secondary transfer portion N in various types of sheets P. As illustrated in FIG. 4, in some sheets P, although the secondary transfer bias values for causing a predetermined current to flow are substantially equal to each other, the detected electrical resistances are greatly different from each other. As described above, the correlation is different depending on the type of the sheet P to be used. Therefore, even if the correlation between the moisture content of the sheet P and the electrical resistance is taken in advance, an appropriate value of the secondary transfer bias may not be calculated from the correlation when the type of the sheet P used by the user is different.

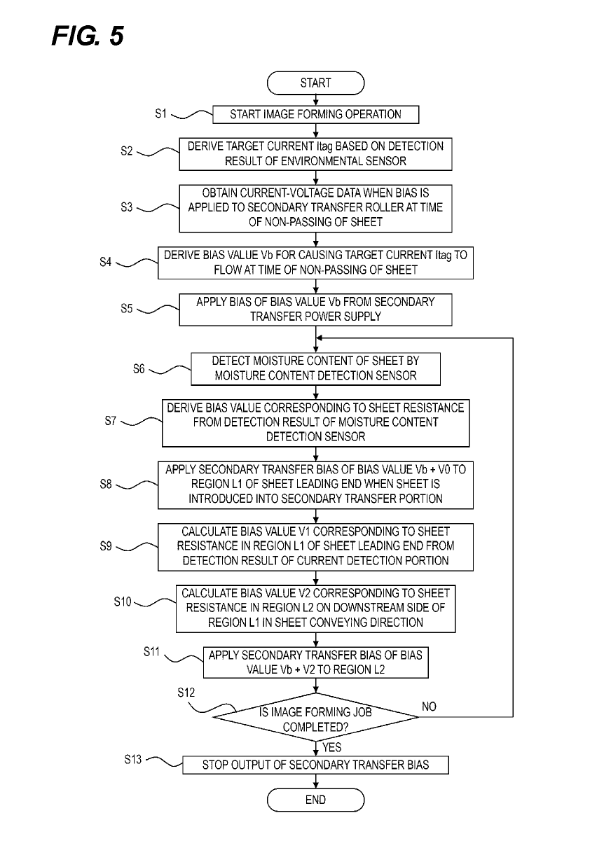

Therefore, in the present embodiment, the electrical resistance of the sheet P detected by the moisture content detection sensor 71 is corrected by the electrical resistance of the sheet P detected in the secondary transfer portion N by the current detection portion 78, and the appropriate value of the secondary transfer bias is set based on the corrected electrical resistance. Hereinafter, the control at the time of applying the secondary transfer bias will be described with reference to the flowchart illustrated in FIG. 5.

As illustrated in FIG. 5, first, when image forming job information is transmitted to the controller 50 by a user operation, the above-described image forming operation is started (S1). The image forming job information includes image information designated by the user, the size (width, length) of the sheet P related to image formation, and information (thickness or basis weight) related to the thickness of the sheet P. It is noted that these pieces of information are specified by, for example, the operation portion 51

Next, the controller 50 reads environmental information with the environmental sensor 75. Here, the ROM 54 stores a table in which environmental information detected by the environmental sensor 75 examined in advance and a target current Itag for transferring the toner image on the intermediate transfer belt 40 to the sheet P are associated with each other. Based on the environmental information detected by the environmental sensor 75, the CPU 52 derives the target current Itag by referring to the table stored in the RAM 53 and writes the derived target current Itag in the RAM 53 (S2). The reason for changing the target current Itag according to the environmental information is that the charge amount of the toner constituting the toner image varies depending on the environment.

The charge amount of the toner image is influenced not only by the surrounding environmental condition but also by the durability history such as the timing of replenishing the developing device 5 with a toner or the amount of toner exiting from the developing device 5. In order to suppress these influences, the charge amount of the toner in the developing device 5 is controlled to be within a certain range. However, if the factor influencing the charge amount of the toner image on the intermediate transfer belt 40 is known in addition to the environmental information, the target current Itag may be changed based on such known information. In addition, a charge amount detection portion which detects the charge amount of the toner image may be provided to set the target current Itag based on the charge amount obtained as the detection result.

Next, before the toner image and the sheet P onto which the toner image is transferred reach the secondary transfer portion N, the controller 50 reads a voltage-current relationship by applying a bias from the secondary transfer power supply 11 in a state in which the secondary transfer roller 10 and the intermediate transfer belt 40 are in contact with each other (S3). Then, from the target current Itag written in the RAM 53 and the voltage-current relationship at this time, a bias value Vb output from the secondary transfer power supply 11 is derived so as to cause the target current Itag to flow at the time of non-passing of the sheet P (S4).

Next, the controller 50 outputs a bias of the bias value Vb from the secondary transfer power supply 11 until the sheet P reaches the secondary transfer portion N (S5). This is because a certain rise time is required so as to stably output a predetermined secondary transfer bias.

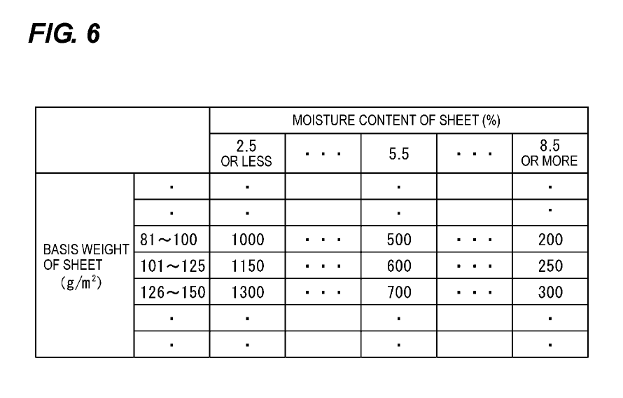

Next, the controller 50 detects the moisture content of the sheet P related to the image formation by the moisture content detection sensor 71 (S6). Here, the ROM 54 stores the table illustrated in FIG. 6, in which the moisture content and basis weight of the sheet P, the resistance value of the sheet P for causing the target current Itag to flow in the secondary transfer portion N in the sheet P passing state, and the secondary transfer bias value for extra output are associated with each other. The secondary transfer bias corresponding to the resistance of the sheet P becomes larger as the thickness of the sheet P becomes larger, even when the moisture content contained in the sheet P is the same. Therefore, in the present embodiment, as illustrated in FIG. 6, a table is configured to set the secondary transfer bias value corresponding to the resistance of the sheet P according to the basis weight (sheet weight per unit area) of the sheet P correlated to the thickness of the sheet P and the moisture content of the sheet P.

In the present embodiment, the table illustrated in FIG. 6 is created in advance by performing preliminary examination thereon by using a predetermined type of sheet and is stored in the ROM 54. However, each table can be configured according to the type of the sheet P, for example, a coated sheet and a non-coated sheet.

Next, the controller 50 derives the secondary transfer bias value corresponding to the resistance of the sheet P based on the detected moisture content information of the sheet P and the basis weight information of the sheet P input by the user with reference to the table illustrated in FIG. 6 (S7). For example, when the basis weight of the sheet P to be used is 81 to 100 g/m² and the moisture content is 5.5%, the secondary transfer bias value corresponding to the resistance of the sheet P is 500 V. When the moisture content is between 2.5% and 5.5%, the secondary transfer bias value corresponding to the resistance of the sheet P is obtained by linear interpolation.

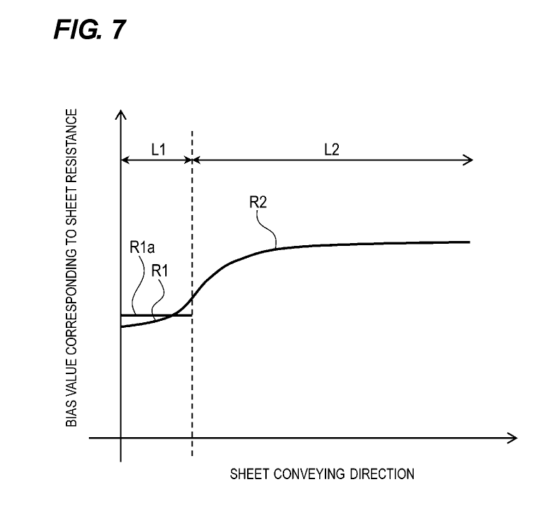

FIG. 7 is a graph illustrating the secondary transfer bias value corresponding to the resistance of the sheet P, which is derived in step S7, along a position in a sheet conveying direction. As described above, in the present embodiment, the moisture content detection sensor 71 detects the moisture content of the sheet P over the entire region in the sheet conveying direction. Therefore, as illustrated in FIG. 7, the secondary transfer bias value corresponding to the resistance of the sheet P varies depending on the change in the resistance of the sheet P in the conveying direction. The secondary transfer bias value corresponding to the resistance of the sheet P is stored in the RAM 53.

Since a voltage at a certain electrical resistance is in a proportional relationship, obtaining the secondary transfer bias value corresponding to the resistance of the sheet P is equivalent to obtaining the electrical resistance of the sheet P. In other words, the electrical resistance of the sheet P is obtained by dividing the secondary transfer bias value corresponding to the resistance of the sheet P by a predetermined current value. In addition, the derived secondary transfer bias value corresponding to the resistance of the sheet P is derived based on the electrical resistance of the sheet P detected from the moisture content detection sensor 71, and is different from that derived from the actual electrical resistance of the sheet P in the secondary transfer portion N.

Next, when the sheet P is introduced into the secondary transfer portion N, the controller 50 applies a bias (voltage) of Vb+V0, which is obtained by superimposing a predetermined bias value V0 on the bias value Vb obtained in step S4, from the secondary transfer power supply 11 until a predetermined amount of the sheet P is conveyed from the introduction (S8). The bias of Vb+V0 is applied by superimposing the bias value V0, which is a predicted value of the secondary transfer bias corresponding to the resistance of the sheet P, on the bias value Vb for causing the target current Itag to flow at the time of non-passing of the sheet P in the secondary transfer portion N. In addition, the region to which the bias of Vb+V0 is applied in the sheet P is a region included in a region (second region) from an end portion of the sheet P on a downstream side in the conveying direction to a position at which the image is not transferred, that is, a region corresponding to a margin portion.

Next, the controller 50 detects the value of the current flowing at the time of applying the bias of the bias value Vb+V0 by using the current detection portion 78, and when there is a deviation between the detected current value and the target current Itag, the controller 50 obtains a bias value necessary for correcting the deviation. Then, a bias value V1 corresponding to the resistance of the sheet P, which causes the target current Itag to flow in the region to which the bias of the bias value Vb+V0 at the leading end of the sheet P is applied, is calculated as follows (S9).

That is, in the sheet P in the secondary transfer portion N, the region to which the bias of the bias value Vb+V0 is applied is set as a region L1, and an average value of the current flowing in the region L1 at this time is set as I1. At this time, the controller 50 uses the following Equation 1 to calculate the bias value V1 corresponding to the resistance of the sheet P, which causes the target current Itag to flow in the region L1, from a variation a (=ΔI/ΔV) of the current with respect to the voltage around the target current Itag based on the voltage-current relationship at the time of non-passing of the sheet obtained in step S3. The variation a of the current is obtained by linearly approximating the current-voltage relationship from the relationship of the current flowing when several kinds of voltages around the target current Itag are applied

Itag−I1=a(V1−V0) (1)

Here, since the electrical resistance of the sheet P is obtained by dividing the bias value V1 corresponding to the resistance of the sheet P by a predetermined current value, obtaining the bias value V1 corresponding to the resistance of the sheet P is equivalent to obtaining the electrical resistance of the sheet P in the region L1 of the sheet P. In addition, the electrical resistance of the sheet P obtained herein is different from that obtained by the moisture content detection sensor 71, and is the actual electrical resistance of the sheet P in the secondary transfer portion N, to which the surface condition or the like of the sheet P detected from the current-voltage relationship when the secondary transfer power supply 11 applies the bias is reflected.

In the present embodiment, although the bias applied within the region L1 is constant, the bias value V1 corresponding to the resistance of the sheet P may be calculated from the value of a current flowing at the time of changing the bias stepwise. In addition, in the present embodiment, the region L1 is set to about 5 to 40 mm from the leading end of the sheet P.

Next, the controller 50 calculates a bias value V2 corresponding to the resistance of the sheet P, which causes the target current Itag to flow in a region L2 (first region) on a upstream side of the region L1 of the leading end of the sheet P in the sheet conveying direction, as described below (S10).

That is, the bias value at each position of the region L1 of the leading end of the sheet P among the bias values corresponding to the resistance of the sheet P derived from the detection result of the moisture content detection sensor 71 illustrated in FIG. 7 is set as R1, the average value of the bias values R1 is set as R1a, and the bias value at each position in the region L2 is set as R2. At this time, the bias value V2 is calculated from the following Equation 2.

V2=V1×R2/R1a (2)

That is, the controller 50 determines the bias value V2 to be applied to the secondary transfer roller 10 when the region L2 of the sheet P passes through the secondary transfer portion N, based on the bias value V1 and the detection results R2 and R1 (R1a) of the regions L1 and L2 obtained by the moisture content detection sensor 71. That is, the controller 50 corrects the bias value R2 corresponding to the resistance of the sheet P which corresponds to the electrical resistance of the region L2 detected by the moisture content detection sensor 71, based on two bias values (V1, R1a) corresponding to the electrical resistances respectively detected in the region L1 by the current detection portion 78 and the moisture content detection sensor 71.

More specifically, the controller 50 performs control similar to the control described below. That is, the electrical resistance in the region L2 of the sheet P, which is detected by the moisture content detection sensor 71, is corrected based on the electrical resistance in the region L1 of the sheet P, which is detected by the current detection portion 78, and the electrical resistance in the region L1 of the sheet P, which is detected by the moisture content detection sensor 71. Then, the bias value V2 corresponding to the resistance of the sheet P in the region L2 is set based on the corrected electrical resistance. Therefore, the bias value V2 corresponding to the resistance of the sheet P in the region L2 is a bias value set based on the actual electrical resistance of the sheet P in the secondary transfer portion N, to which the surface condition of the sheet P is reflected.

Next, in the region L2 of the sheet P, the controller 50 applies the bias of Vb+V2, which is obtained by superimposing the bias value V2 on the bias value Vb for causing the target current Itag to flow at the time of non-passing of the sheet P, from the secondary transfer power supply 11 (S11). In other words, the secondary transfer power supply 11 applies the bias of the bias value Vb+V0 to the region L1 of the sheet P and then applies the bias of the bias value Vb+V2 so as to transfer the toner image in the region L2.

That is, the controller 50 sets the bias (voltage) to be applied from the secondary transfer power supply 11 to the secondary transfer roller 10 in a transfer period in which the toner image is transferred onto the sheet P in the secondary transfer portion N as follows. First, in a detection period prior to the transfer period, the controller 50 detects information corresponding to the electrical resistance of the sheet P by using the moisture content detection sensor 71. In addition, in the detection period, when a region corresponding to a margin portion to which the toner image on the downstream side of the sheet P in the conveying direction is not transferred passes through the secondary transfer portion N, the controller 50 applies the bias from the secondary transfer power supply 11 and detects the relationship between the voltage and the current by using the current detection portion 78. The bias (voltage) to be applied to the secondary transfer roller 10 by the secondary transfer power supply 11 in the transfer period in which the toner image is transferred is set based on the detection result of the moisture content detection sensor 71 and the detection result of the current detection portion 78.

After that, when the image forming job continues in a continuous sheet passing job or the like, the process returns to step S6 to detect the moisture content for each sheet P related to the image formation and then apply the secondary transfer bias in a similar manner as described above. After the image forming job is completed, the output of the secondary transfer bias is stopped (S12, S13).

As in the above control, the electrical resistances of the sheet P are detected at a plurality of positions in the sheet conveying direction from the detection result of the moisture content detection sensor 71, and the bias value to be applied by the secondary transfer power supply 11 is changed according to a change in the detected electrical resistance of the sheet P. Therefore, even when there is unevenness in the electrical resistance of the sheet P in the sheet conveying direction, the secondary transfer bias can be made appropriate.

In addition, the electrical resistance of the sheet P detected by the moisture content detection sensor 71 is corrected based on the actual electrical resistance of the sheet P in the secondary transfer portion N, which is detected by the current detection portion 78, and an appropriate value of the secondary transfer bias is set based on the corrected electrical resistance and then applied. Therefore, it is possible to apply an appropriate secondary transfer bias according to not only the unevenness of the resistance of the sheet P in the sheet conveying direction but also the difference in the surface state of the sheet P.

It is noted that the electrical resistance of the intermediate transfer belt 40 or the secondary transfer roller 10 which forms the secondary transfer portion N varies depending on the environment, energization durability, and the like, and the variation in the resistance changes the bias value Vb for causing the target current Itag to flow at the time of non-passing of the sheet P. Therefore, in a case where the number of sheets on which an image is formed is large in the same image forming job or in a case where the environmental variation is large, the control may be performed such that the detection of the environmental information or the resetting of the bias value Vb is performed by returning to step S2 described above at each image formation. This makes it possible to make the secondary transfer bias value more appropriate.

### Second Embodiment

Next, a second embodiment of the image forming apparatus according to the present invention will be described with reference to the drawings. The same portions as those of the first embodiment are denoted by the same drawings and the same reference numerals, and the description thereof will be omitted.

In the first embodiment, the moisture content detection sensor 71 obtains the bias value corresponding to the resistance of the sheet P as a profile in the entire region in the sheet conveying direction, and the secondary transfer bias is controlled as appropriate accordingly. However, although the resistance unevenness of the sheet P caused by the unevenness of the moisture content contained in the sheet P is different in the end portion and the central portion of the sheet, there are many cases where there is no great difference in the portion other than the end portion.

For example, there is known a configuration that has a mechanism for loosening sheets one by one by blowing air to the leading edges of the sheets so as to prevent double feeding when the sheet in a sheet feeding cassette is fed. In this configuration, the moisture content remarkably changes at the leading edge of the sheet against which the air hits. However, the region in which the moisture content is changed by the air is largely determined according to the arrangement or air volume setting.

In the present embodiment, as the mechanism for feeding the sheet P in the sheet feeding cassette (not illustrated), the above-described mechanism for loosening the sheets one by one by blowing the air is provided. The air volume is set such that the air volume increases as the thickness of the sheet P increases, but the region in which the electrical resistance of the sheet P changes as the moisture content changes is a region of about 50 to 60 mm from the leading edge of the sheet. The change in the electrical resistance of the other regions is slight.

In this case, the electrical resistances of several representative points can be detected even if the electrical resistance of the sheet P is not finely taken as the profile in the sheet conveying direction, and the secondary transfer bias can be made appropriate even in the configuration that changes the secondary transfer bias in several stages according to the electrical resistance. Therefore, in the present embodiment, the controller 50 partitions the sheet P into several representative sections (regions) in the sheet conveying direction, controls the secondary transfer bias based on the average value of the electrical resistance of the sheet P detected from the detection result of the moisture content detection sensor 71 in the sections (regions).

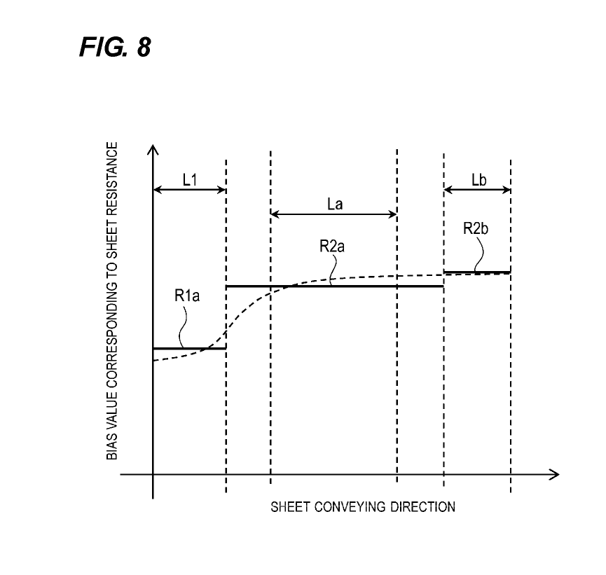

FIG. 8 is a graph illustrating the secondary transfer bias value corresponding to the resistance of the sheet P determined by the controller 50 with reference to the table illustrated in FIG. 6, based on the moisture content of the sheet P detected by the moisture content detection sensor 71 and the basis weight information of the sheet P. As illustrated in FIG. 8, the controller 50 partitions the sheet P into a region L1 of a leading end, a region La of a central portion, and a region Lb of a rear end with respect to the sheet conveying direction.

It is noted that the region L1 corresponds to a region in which the moisture content of the sheet P greatly changes when the air hits, and specifically a region of about 50 to 60 mm from the leading end of the sheet P. In addition, the region La is a region of ±10 to 40 mm from the center of the sheet P in the sheet conveying direction, and the region Lb is a region of about 5 to 40 mm from the rear end of the sheet P. It is noted that the region L1 of the leading end of the sheet P may be a region corresponding to a margin portion in which a toner image is not transferred within a region in which the moisture content of the sheet P greatly changes when the air hits. In addition, the region Lb of the sheet P may be a region which is rear end side of the sheet P excluding a margin portion of a rear end of the sheet P. That is, the region Lb of the sheet P may be a rear end of the region in which a toner image is transferred.

The controller 50 sets the average value of the bias values corresponding to the resistances of the sheet P in the region La as R2a and sets the average value of the bias values corresponding to the resistances of the sheet P in the region Lb as R2b. Then, as in the first embodiment, the average values R2a and R2b are corrected based on the two bias values corresponding to the electrical resistances respectively detected by the current detection portion 78 and the moisture content detection sensor 71 in the region L1.

That is, in the control at the time of applying the secondary transfer bias in the first embodiment, the bias value V2 (voltage) corresponding to the resistance of the sheet P derived in step S10 illustrated in FIG. 5 is calculated in the region from the rear end of the region L1 to the leading end of the region Lb using the following Equation 3, and is calculated in the region Lb by using the following Equation 4. It is noted that the control at the time of applying the secondary transfer bias except step S10 illustrated in FIG. 5 is similar to the control of the first embodiment.

V2=V1×R2a/R1a (3)

V2=V1×R2b/R1a (4)

That is, the controller 50 performs control similar to the control described below. That is, the sheet P is partitioned into the region L1 of the leading end, the region La of the central portion, and the region Lb of the rear end with respect to the conveying direction. Then, the average value of the electrical resistances of the sheet P obtained from the moisture content of the sheet P detected by the moisture content detection sensor 71 in each of the partitioned regions is set as the electrical resistance of the sheet P used for setting the bias value V2, and the bias value V2 is derived as in the first embodiment.

Therefore, as in the first embodiment, it is possible to apply an appropriate secondary transfer bias according to not only the unevenness of the resistance of the sheet P in the sheet conveying direction but also the difference in the surface state of the sheet P.

In the present embodiment, since the moisture content detection sensor 71 detects the moisture content of the sheet P in three representative sections in the sheet conveying direction, there is also a region that is not detected by the moisture content detection sensor 71. Since the electrical resistance obtained from the detection result is averaged, there is also a difference between a maximum value and a minimum value of the electrical resistance in the section. Due to such factors, there is a possibility that the secondary transfer bias value deviates from an appropriate value. Therefore, it is desirable to suppress the deviation of the secondary transfer bias from the appropriate value by appropriately changing the range or the position read by the moisture content detection sensor 71 according to each configuration.

### Third Embodiment

Next, a third embodiment of the image forming apparatus according to the present invention will be described with reference to the drawings. The same portions as those of the first and second embodiments are denoted by the same drawings and the same reference numerals, and the description thereof will be omitted.

In the first and second embodiments, when the sheet P is introduced into the secondary transfer portion N, the controller 50 performs constant voltage control on the secondary transfer power supply 11 in the region L1 of the leading end of the sheet P. From the value of the current flowing at this time, the bias value V1 corresponding to the resistance of the sheet P, which causes the target current Itag to flow in the region L1 of the leading end of the sheet P, is obtained.

However, when the constant current control is performed to control the voltage such that a constant current flows in the region L1 of the leading end of the sheet P, the derivation of the bias value V1 becomes easier. Therefore, in the present embodiment, when the bias is applied from the secondary transfer power supply 11 to the region L1 of the leading end of the sheet P, the CPU 52 performs constant current control on the secondary transfer power supply 11 such that the target current Itag flows.

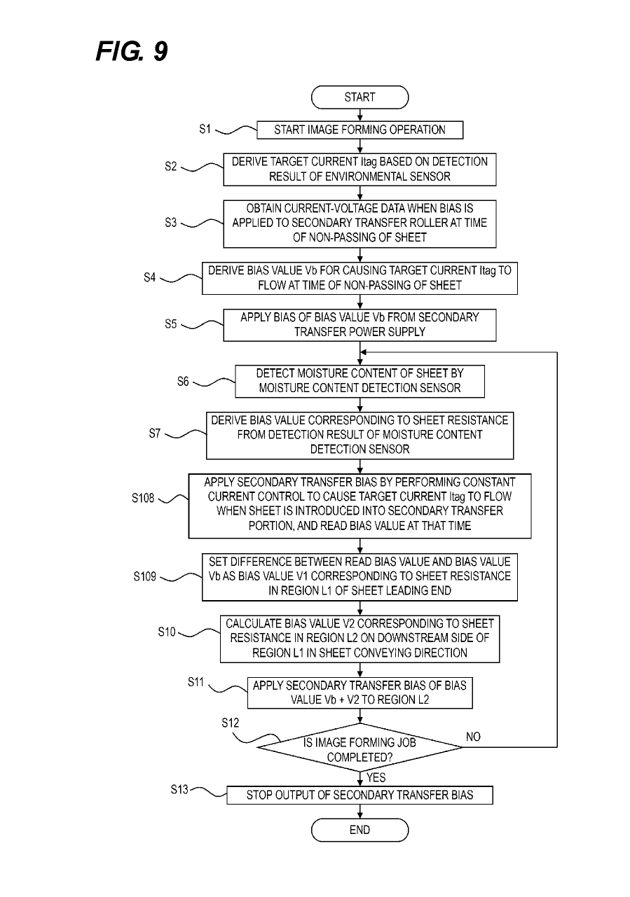

Hereinafter, the control at the time of applying the secondary transfer bias in the present embodiment will be described with reference to the flowchart illustrated in FIG. 9. In FIG. 9, the same reference numerals are assigned to steps of performing the same processing as the steps described in the first embodiment with reference to FIG. 5, and the description thereof is simplified or omitted.

First, an image forming operation is started based on image forming job information, and a target current Itag is set based on environmental information detected by the environmental sensor 75 (S1, S2).

Next, before a sheet P reaches a secondary transfer portion N, the controller 50 reads a voltage-current relationship by applying a bias from the secondary transfer power supply 11 (S3). Then, from the target current Itag and the voltage-current relationship at this time, a bias value Vb output from the secondary transfer power supply 11 is calculated so as to cause the target current Itag to flow at the time of non-passing of the sheet P (S4). After that, a secondary transfer bias of the bias value Vb is applied from the secondary transfer power supply 11 (S5).

Next, the controller 50 detects a moisture content of the sheet P by using the moisture content detection sensor 71, and determines a secondary transfer bias value corresponding to a resistance of the sheet P based on the moisture content information and basis weight information of the sheet P input by a user (S6, S7).

Next, when the sheet P is introduced into the secondary transfer portion N, the controller 50 performs constant current control on the secondary transfer power supply 11 such that the target current Itag flows in the region L1 of the leading end of the sheet P, and then applies the bias (first bias). In addition, the controller 50 reads the bias value at this time (S108).

Next, the controller 50 derives a difference between the read bias value and the bias value Vb for causing the target current Itag to flow at the time of non-passing of the sheet P, as a bias value V1 corresponding to the resistance of the sheet P, which causes the target current Itag to flow to the region L1 of the leading end of the sheet P (S109).

Next, the controller 50 calculates a bias value V2 corresponding to the resistance of the sheet P, which causes the target current Itag to flow in the region L2 on a downstream side of the region L1 of the leading end of the sheet P in the sheet conveying direction, from Equation 2 described in the first embodiment (S10). After that, in the region L2 of the sheet P, the controller 50 applies Vb+V2 (second bias), which is obtained by superimposing the bias value V2 obtained in step S10 on the bias value Vb for causing the target current Itag to flow at the time of non-passing of the sheet P, from the secondary transfer power supply 11 (S11).

After that, when the image forming job continues in a continuous sheet passing job or the like, the process returns to step S6 to detect the moisture content for each sheet P related to the image formation and apply the secondary transfer bias in a similar manner as described above. After the image forming job is completed, the output of the secondary transfer bias is stopped (S12, S13).

Therefore, after the bias value V1 is more easily derived, it is possible to apply an appropriate secondary transfer bias according to not only the unevenness of the electrical resistance of the sheet P in the sheet conveying direction but also the difference in the surface state of the sheet P.

The reason why the constant current control is not performed when the secondary transfer bias is applied to the region on the downstream side from the region L1 of the leading end of the sheet P is that, when the resistance unevenness occurs in a sheet width direction orthogonal to the sheet conveying direction, a necessary current may not be supplied to a portion in which a toner image is present.

That is, between the portion in which the toner is present and the portion in which the toner is absent, the portion in which the toner is absent has a lower resistance, and thus the current more easily flows in that portion. Therefore, when the constant current control is performed, a relatively large amount of current flows in the low resistance portion where the toner is absent, and only a current lower than an apparent current flows in the high resistance portion where the toner is present. Therefore, a desired current may not be supplied to the toner image portion.

Therefore, on the assumption that there is a toner in the entire region in the sheet width direction, the current necessary for transferring the toner onto the sheet P is set as the target current Itag, and the value of the secondary transfer bias necessary for causing the target current Itag to flow is applied under the constant voltage control. As a result, even when the portion in which the toner image is present and the portion in which the toner image is absent are mixed in the sheet width direction, a necessary current can be easily supplied to the portion in which the toner is present.

In the first to third embodiments, the moisture content detection sensor 71 is used as a first detection portion which detects information corresponding to the electrical resistance of the sheet P. However, the first detection portion can use other configurations, in addition to the moisture content detection sensor 71.

For example, as another configuration, it is also possible to use an electrostatic capacitance detection sensor which detects an electrostatic capacitance of the sheet P. That is, although the relative permittivity of the sheet fiber is about 2 to 3, the relative permittivity of water is as large as about 80. Therefore, the detection results of the relative permittivity and the electrostatic capacitance vary depending on the ratio of the moisture content contained in the sheet P. Therefore, the correlation between the electrostatic capacitance detected by the electrostatic capacitance detection sensor or information concerning the electrostatic capacitance and the moisture content of the sheet P is obtained in advance, and this information is stored in advance in the ROM 54. Thus, the moisture content of the sheet P can be detected by the electrostatic capacitance detection sensor. Further, the resistance of the sheet P can be detected from the detected moisture content of the sheet P, as in the moisture content detection sensor 71. Since the electrostatic capacitance also varies depending on the thickness of the sheet P, the thickness of the sheet P or information related to the thickness such as the basis weight may be read by the operation portion 51, and the moisture content of the sheet P may be detected by correcting the detection result of the electrostatic capacitance detection sensor.

In addition, as another configuration, conductive rollers may be provided on the sheet conveying path on the upstream side of the secondary transfer portion N, and the electrical resistance of the sheet P may be detected from the voltage-current relationship when a predetermined bias is applied to the pair of rollers. Even in this case, however, the detected electrical resistance and the electrical resistance of the sheet P in the secondary transfer portion N are different because the contact state between the sheet P and the counter member is different. Therefore, as in the first to third embodiments, it is desirable to control the secondary transfer bias by using both the electrical resistance obtained from the first detection portion and the voltage-current detection of the secondary transfer portion N.

In the first to third embodiments, the present invention has been described with reference to the full-color image forming apparatus using the intermediate transfer system. However, the present invention is not limited thereto and can be applied to an image forming apparatus using a monochromatic system. That is, the present invention can also be applied to a configuration in which the sheet P is nipped and conveyed together with the photosensitive drum 1, and the toner image on the photosensitive drum 1 (on the image bearing member, on the photosensitive member) is directly transferred onto the sheet P by applying the transfer bias.

In the first to third embodiments, the bias value V1 derived from the current flowing when the region L1 (margin portion) of the first sheet P passes through the secondary transfer portion N is acquired. Then, an example has been described in which, based on the bias value V1, the bias value V2 to be applied to the secondary transfer roller 10 is acquired when the region L2 (image region) of the first sheet P passes through the secondary transfer portion N. However, the present invention is not limited to this example. For example, when the types of the sheets P are the same, the bias value V2 to be applied to the secondary transfer roller 10 when the regions L2 of the second and subsequent sheets P pass through the secondary transfer portion N may be determined based on the bias value V1 obtained at the leading end of the first sheet P. More specifically, the bias to be applied to the secondary transfer roller 10 when the region L2 of the second sheet P (second recording material) passes through the secondary transfer portion N may be determined based on the bias value V1 obtained at the first sheet P (first recording material) and the detection result obtained by detecting the moisture content of the region L2 of the second sheet P by the first detection portion. Such control is effective when the transfer bias cannot be timely switched in the first sheet P.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-38476, filed Mar. 1, 2017, which is hereby incorporated by reference herein in its entirety.

What is claimed is:

1. An image forming apparatus comprising:
an image bearing member configured to bear a toner image;
a transfer member configured to come in contact with the image bearing member to form a transfer portion which transfers the toner image borne on the image bearing member to a recording material;
a power supply configured to apply a voltage to the transfer member;
a conveyance path through which the recording material is conveyed toward the transfer portion;
a first detection portion disposed on the conveyance path and configured to detect information concerning a moisture content of the recording material;
a second detection portion configured to detect a current flowing when the power supply applies a voltage to the transfer member or the applied voltage; and
a controller configured to control a bias to be applied to the transfer member when the recording material passes through the transfer portion,
wherein the controller controls a voltage to be applied to the transfer member when a first region of the recording material passes through the transfer portion, based on a detection result obtained by detecting the first region of the recording material by the first detection portion and a detection result obtained by detecting a second region of the recording material which is downstream of the first region with respected to a conveying direction of the recording material by the first detection portion, and a detection result detected by the second detection portion at a timing when the second region passes through the transfer portion.

2. The image forming apparatus according to claim 1,
wherein the second region is a margin portion of a leading end of the recording material.

3. The image forming apparatus according to claim 1,
wherein the first region is a region excluding a margin portion of a leading end and a rear end of the recording material in a conveying direction.

4. The image forming apparatus according to claim 3,
wherein the controller controls a voltage to be applied to the transfer member by the power supply when the first region passes through the transfer portion, based on an average value of detection results obtained by detecting different area of the first region by the first detection portion.

5. The image forming apparatus according to claim 1, further comprising an environmental sensor configured to detect temperature or humidity,
wherein the controller controls a voltage to be applied to the transfer member when the first region passes through the transfer portion, based on a detection result of the environmental sensor.

6. The image forming apparatus according to claim 1,
wherein the controller performs constant current control on the power supply when the second region passes through the transfer portion, and performs constant voltage control on the power supply when the first region passes through the transfer portion.

7. The image forming apparatus according to claim 1,
wherein the first detection portion detects information concerning an electrostatic capacitance of the recording material.

8. The image forming apparatus according to claim 1,
wherein the transfer member is a conductive roller member.

9. The image forming apparatus according to claim 1,
wherein the image bearing member is a photosensitive member.

10. The image forming apparatus according to claim 1, further comprising a photosensitive member configured to bear a toner image,
wherein the image bearing member is an intermediate transfer member onto which the toner image borne on the photosensitive member is transferred.

11. An image forming apparatus comprising:
an image bearing member configured to bear a toner image;
a transfer member configured to come in contact with the image bearing member to form a transfer portion which transfers the toner image borne on the image bearing member to a recording material;
a power supply configured to apply a voltage to the transfer member;
a conveyance path through which the recording material is conveyed toward the transfer portion;
a first detection portion disposed on the conveyance path and configured to detect information concerning a moisture content of the recording material;
a second detection portion configured to detect a current flowing when the power supply applies a voltage to the transfer member or the applied voltage; and
a controller configured to control a bias to be applied to the transfer member when the recording material passes through the transfer portion,
wherein the controller controls a voltage to be applied to the transfer member when a first recording material passes through the transfer portion, based on a detection result obtained by detecting the first recording material by the first detection portion, a detection result obtained by detecting a second recording material which is conveyed before the first recording material by the first detection portion, and a detection result detected by the second detection portion at a timing when the second recording material passes through the transfer portion.
